(19) United States
(12) Patent Application Publication
(10) Pub. No.: US 2013/0300939 A1
(43) Pub. Date: Nov. 14, 2013

(54) SYSTEM AND METHOD FOR JOINT SPEAKER AND SCENE RECOGNITION IN A VIDEO/AUDIO PROCESSING ENVIRONMENT

(71) Applicants: Jim Chen Chou, San Jose, CA (US); Sachin Kajarekar, Sunnyvale, CA (US); Jason J. Catchpole, Hamilton (NZ); Ananth Sankar, Palo Alto, CA (US)

(72) Inventors: Jim Chen Chou, San Jose, CA (US); Sachin Kajarekar, Sunnyvale, CA (US); Jason J. Catchpole, Hamilton (NZ); Ananth Sankar, Palo Alto, CA (US)

(73) Assignee: Cisco Technology, Inc.

(21) Appl. No.: 13/469,886

(22) Filed: May 11, 2012

(51) Int. Cl. H04N 5/14

(52) U.S. Cl. 348/700; 348/E05.062

(57) ABSTRACT

An example method is provided and includes receiving a media file that includes video data and audio data; determining an initial scene sequence in the media file; determining an initial speaker sequence in the media file; and updating a selected one of the initial scene sequence and the initial speaker sequence in order to generate an updated scene sequence and an updated speaker sequence respectively. The initial scene sequence is updated based on the initial speaker sequence, and wherein the initial speaker sequence is updated based on the initial scene sequence.

### TECHNICAL FIELD

This disclosure relates in general to the field of communications and, more particularly, to a system and a method for joint speaker and scene recognition in a video/audio processing environment.

### BACKGROUND

The ability to effectively gather, associate, and organize information presents a significant obstacle for component manufacturers, system designers, and network operators. As new communication platforms and technologies become available, new protocols should be developed in order to optimize the use of these emerging protocols. With the emergence of high bandwidth networks and devices, enterprises can optimize global collaboration through creation of videos, and personalize connections between customers, partners, employees, and students through user-generated video content. Widespread use of video and audio in turn drives advances in technology for video/audio processing, video creation, uploading, searching, and viewing.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified diagram of one example embodiment of a system in accordance with the present disclosure;

FIG. 2 is a simplified block diagram illustrating additional details of the system;

FIG. 3 is a simplified diagram illustrating an example operation of an embodiment of the system;

FIG. 4 is a simplified flow diagram illustrating example operational activities that may be associated with embodiments of the system;

FIG. 5 is a simplified diagram illustrating additional details of example operational activities that may be associated with embodiments of the system; and

FIG. 6 is a simplified flow diagram illustrating other additional details of example operational activities that may be associated with embodiments of the system.

### DETAILED DESCRIPTION OF EXAMPLE EMBODIMENTS

### Overview

An example method is provided and includes receiving a media file that includes video data and audio data. The term “receiving” in such a context is meant to include any activity associated with accessing the media file, reception of the media file over a network connection, collecting the media file, obtaining a copy of the media file, etc. The method also includes determining (which includes examining, analyzing, evaluating, identifying, processing, etc.) an initial scene sequence in the media file and determining an initial speaker sequence in the media file. The ‘initial scene sequence’ can be associated with any type of logical segmentation, organization, arrangement, design, formatting, titling, labeling, pattern, structure, etc. associated with the media file. The ‘initial speaker sequence’ can be associated with any identification, enumeration, organization, hierarchy, assessment, or recognition of the speakers (or any element that would identify the speaker (e.g., their user IDs, their IP address, their job title, their avatar, etc.)). The method also includes updating (which includes generating, creating, revising, modifying, etc.) a selected one of the initial scene sequence and the initial speaker sequence in order to generate an updated scene sequence and an updated speaker sequence respectively. In this context, either of the initial sequence or the initial speaker sequence can be updated, or both can be updated depending on the circumstance. The initial scene sequence can be updated based on the initial speaker sequence, and wherein the initial speaker sequence is updated based on the initial scene sequence.

In more specific instances, the method can include detecting a plurality of scenes and a plurality of speakers in the media file. The method may also include modeling the video data as a hidden Markov Model (HMM) with hidden states corresponding to different scenes of the media file; and modeling the audio data as another HMM with hidden states corresponding to different speakers of the media file. The actual media file can include any type of data (e.g., video data, voice data, multimedia data, audio data, real-time data, streaming data, etc.), or any suitable combinations thereof that would be suitable for the operations discussed herein.

In particular example configurations, the updating of the initial scene sequence includes: computing a conditional probability of the initial scene sequence given the initial speaker sequence; estimating the updated scene sequence based on at least the conditional probability of the initial scene sequence given the initial speaker sequence; comparing the updated scene sequence with the initial scene sequence; and updating the initial determined scene sequence to the updated scene sequence if there is a difference between the updated scene sequence and the initial scene sequence. In specific embodiments, an initial conditional probability of the scene sequence given the speaker sequence may be estimated through off-line training sequences using supervised (or unsupervised) learning algorithms.

### Example Embodiments

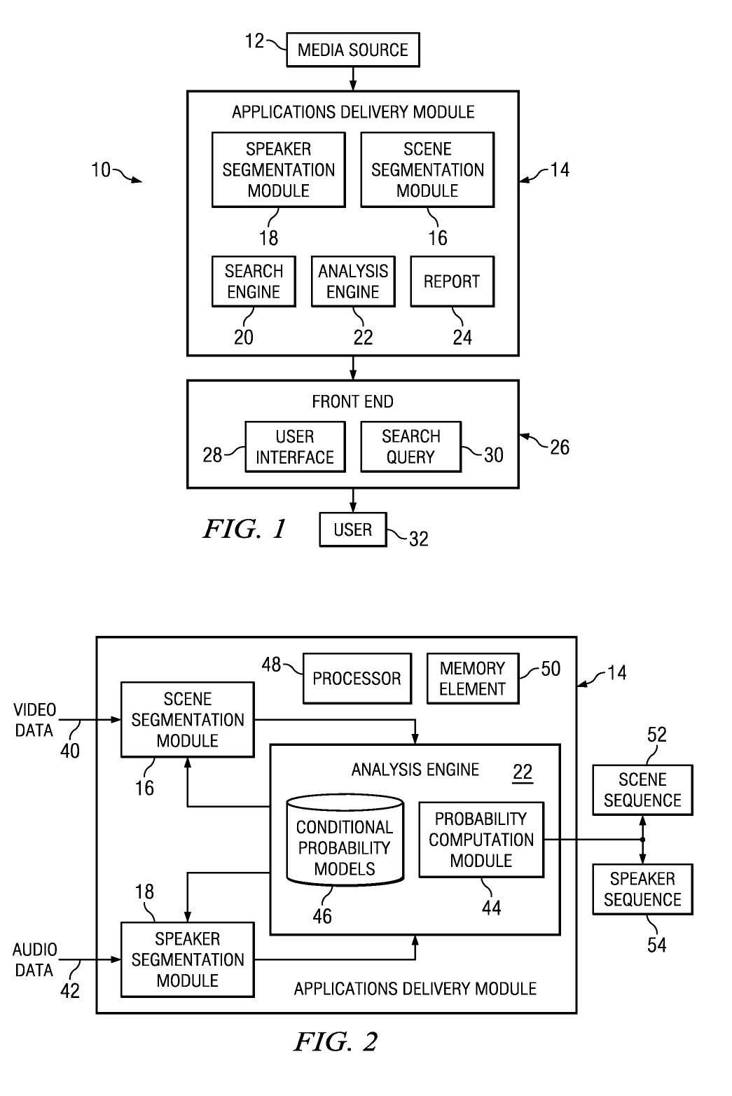

Turning to FIG. 1, FIG. 1 is a simplified block diagram of a system 10 for joint speaker and scene recognition in a video/audio processing environment in accordance with one example embodiment of the present disclosure. FIG. 1 illustrates a media source 12 that includes multiple media files. Media source 12 may interface with an applications delivery module 14, which may include a scene segmentation module 16, a speaker segmentation module 18, a search engine 20, an analysis engine 22, and a report 24. The architecture of FIG. 1 may include a front end 26 provisioned with a user interface 28, and a search query 30. A user 32 can access front end 26 to find video clips or audio clips (e.g., sections within the media file) from one or more media files in media source 12 having a particular scene or a particular speaker, or combinations thereof.

A video is typically composed of frames (e.g., still pictures), a group of which can form a shot. Shots are the smallest video unit containing temporal semantics such as action, dialog, etc. Shots may be created by different camera operations, video editing, etc. A group of semantically related shots constitutes a scene, and a collection of scenes forms the video of the media file. In some embodiments, the semantics may be based on content. For example, a series of shots may show the following scenes: (1) “Welcome Scene,” with a first speaker welcoming a second speaker before a seated audience; (ii) “Tour Scene,” with the second speaker making a tour of a company manufacturing floor; and (iii) “Farewell Scene,” with the first speaker bidding goodbye to the second speaker. The Welcome Scene may include several shots such as: a shot focusing on a front view of the first speaker welcoming the second speaker while standing at a lectern; another shot showing a side view of the second speaker listening to the welcome speech; yet another shot showing the audience cheering; etc. The Tour Scene may include several shots such as shots in which the second speaker gazes at a machine; the second speaker talks to a worker on the floor; etc. The Farewell Scene may comprise a single shot showing the first speaker bidding good-bye to the second speaker.

According to embodiments of the present disclosure, the several shots in the example video may be segmented into different scenes based on various criteria obtained from user preferences and/or search queries. The shots can be arranged in any desired manner based on particular needs to form the scenes. Further, the scenes may be arranged in any desired manner based on particular needs to form video sequences. For example, a video sequence obtained from video segmentation may include the following video sequence (e.g., arranged in a temporal order of occurrence): {Welcome Scene; Tour Scene; Farewell Scene}. The individual scenes may be identified by appropriate identifiers, timestamps, or any other suitable mode of identification. Note that various types of segmentation are possible based on selected themes, ordering manner, or any other criteria. For example, the entire example video may be categorized into a single theme such as a “Second Speaker Visit Scene.” In another example, the Welcome Scene alone may be categorized into a “Speech Scene” and a “Cheering Scene,” etc.

Likewise, the example video may include several speakers speaking at different times during the video. The example video may be segmented according to the number of speakers, for example, first speaker; second speaker; audience; workers; etc. Embodiments of the present disclosure may perform speaker segmentation by detecting changes of speakers talking and isolating the speakers from background noise conditions. Each speaker may be assigned a unique identifier. In some embodiments, each speaker may also be recognized based on information from associated speaker identification systems. A speaker sequence (i.e., speakers arranged in an order) in the example video obtained from such speaker segmentation may include the following speaker sequence (e.g., arranged in a temporal order of occurrence): {first speaker; audience; second speaker; worker; first speaker}.

In other embodiments, the semantics for defining the scene may be based on end point locations, which are the geographical locations of the video shot origin. For example, in a Cisco® Telepresence meeting, a scene may be differentiated from another scene based on the end point location of the shots such as by identification of the Telepresence unit that generated the shots. A series of video shots of a speaker from San Jose, Calif. in the Telepresence meeting may form one scene, whereas another series of video shots of another speaker from Raleigh, N.C., may form another scene.

In yet other embodiments, the semantics for defining the scene may be based on metadata of the video file. For example, metadata in a media file of a teleconference recording may indicate the phone numbers of the callers. The metadata may indicate that speakers A and B are calling from a particular phone, whereas speaker B is calling from another phone. Based on the metadata, audio from speakers A and B may be segmented into a scene; whereas audio from speaker B may be segmented into another scene.

User 32 may search the example video for various scenes (e.g., Welcome Scene, Farewell Scene, etc.) and/or various speakers (e.g., first speaker, audience, second speaker, etc.) In particular embodiments, system 10 may use speaker segmentation algorithms to improve accuracy of scene segmentation algorithms and vice versa to enable efficient and accurate identification of various scenes and speakers, segment the video accordingly, and display the results to user 32. Embodiments of system 10 may enhance the performance of scene segmentation and speaker segmentation by iteratively exploiting dependencies that may exist between scenes and speakers.

For purposes of illustrating certain example techniques of system 10, it is important to understand the communications that may be traversing the network. The following foundational information may be viewed as a basis from which the present disclosure may be properly explained. Such information is offered earnestly for purposes of explanation only and, accordingly, should not be construed in any way to limit the broad scope of the present disclosure and its potential applications.

Part of a potential visual communications solution is the ability to record conferences to a content server. This allows the recorded conferences to be streamed live to people interested in the conference but who do not need to participate. Alternatively, the recorded conferences can be viewed later by either streaming or downloading the conference in a variety of formats as specified by the user who sets up the recording (referred to as content creators). Users wishing to either download or stream recorded conferences can access a graphical user interface (GUI) for the content server, which allows them to browse and search through the conferences looking for the one they wish to view. Thus, users may watch the conference recording at a time more convenient to them. Additionally, it allows them to watch only the portions of the recording they are interested in and skip the rest, saving them time.

It is often useful to segment the videos into scenes that may be either searched later, or individually streamed out to users based on their preferences. One method of segmenting a video is based upon speaker identification; the video is parsed based upon the speaker who is speaking during an instant of time and all of the video segments that correspond to a single speaker are clustered together. Another method of segmenting a video is based upon scene identification; the video is parsed based upon scene changes and all of the video segments that correspond to a single scene are clustered together.

Speaker segmentation and identification can be implemented by using speaker recognition technology to process the audio track, or face detection and recognition technology to process the video track. Scene segmentation and identification can be implemented by scene change detection and image recognition to determine the scene identity. Both speaker and scene segmentation/identification may be error prone depending on the quality of the underlying video data, or the assumed models. Sometimes, the error rate can be very high, especially if there are multiple speakers and scenes with people talking in a conversational style and several switches between speakers.

Several methodologies exist to perform scene segmentation. For example, in one example methodology, temporal video segmentation may be implemented using a Markov Chain Monte Carlo (MCMC) technique to determine boundaries between scenes. In this approach, arbitrary scene boundaries are initialized at random locations. A posterior probability of the target distribution of the number of scenes and their corresponding boundary locations are computed based on prior models and data likelihood. Updates to model parameters are controlled by a hypothesis ratio test in the MCMC process, and samples are collected to generate the final scene boundaries. Other video segmentation techniques include pixel-level scene detection, likelihood ratio (e.g., comparing blocks of frames on the basis of statistical characteristics of their intensity levels), twin comparison method, detection of camera motion, etc.

Scene segmentation may also utilize scene categorization concepts. Scenes may be categorized (e.g., into semantically related content, themes, etc.) for various purposes such as indexing scenes, and searching. Scene categories may be recognized from video frames using various techniques. For example, holistic descriptions of a scene may be used to categorize the scene. In other examples, a scene may be interpreted as a collection of features (e.g., objects). Geometrical properties, such as vertical/horizontal geometrical attributes, approximate depth information, and geometrical context, may be used to detect features (e.g., objects) in the video. Scene content, such as background, presence of people, objects, etc. may also be used to classify and segment scenes.

Techniques exist to segment video into scenes using audio and video features. For example, environmental sounds and background sounds can be used to classify scenes. In one such technique, the audio and video data are separately segmented into scenes. The audio segmentation algorithm determines correlations amongst the envelopes of audio features. The video segmentation algorithm determines correlations amongst shot frames. Scene boundaries in both cases are determined using local correlation minima and the resulting segments are fused using a nearest neighbor algorithm that is further refined using a time-alignment distribution. In another technique, a fuzzy k-means algorithm is used for segmenting the auditory channel of a video into audio segments, each belonging to one of several classes (silence, speech, music etc.). Following the assumption that a scene change is associated with simultaneous change of visual and audio characteristics, scene breaks are identified when a visual shot boundary exists within an empirically set time interval before or after an audio segment boundary.

In yet another technique, use of visual information in the analysis is limited to video shot segmentation. Subsequently, several low-level audio descriptors (e.g., volume, sub-band energy, spectral and cepstral flux) are extracted for each shot. Finally, neighboring shots whose Euclidean distance in the low-level audio descriptor space exceeds a dynamic threshold are assigned to different scenes. In yet another technique, audio and visual features are extracted for every visual shot and input to a classifier, which decides on the class membership (scene-change/non-scene-change) of every shot boundary.

Some techniques use audio event detection to implement scene segmentation. For example, one such technique relies on an assumption that the presence of the same speaker in adjacent shots indicates that these shots belong to the same scene. Speaker diarization is the process of partitioning an input stream into (e.g., homogeneous) segments according to the speaker identity. This could include, for example, identifying (in an audio stream), a set of temporal segments, which are homogeneous, according to the speaker identity, and then assigning a speaker identity to each speaker segment. The results are extracted and combined with video segmentation data in a linear manner. A confidence level of the boundary between shots also being a scene boundary based on visual information alone is calculated. The same procedure is followed for audio information to calculate another confidence level of the scene boundary based on audio information. Subsequently, these confidence values are linearly combined to result in an overall audiovisual confidence value that the identified scene boundary is indeed the actual scene boundary. However, such techniques do not update a speaker identification based on the scene identification, or vice versa.

Several methodologies exist to perform speaker segmentation and/or identification also. For example, speaker segmentation may be implemented using Bayesian information criterion to allow for a real-time implementation of simultaneous transcription, segmentation, and speaker tracking. Speaker segmentation may be performed using Mel frequency cepstral coefficients features using various techniques to determine change points from speaker to speaker. For example, the input audio stream may be segmented into silence-separated speech parts. In another example, initial models may be created for a closed set of acoustic classes (e.g., telephone-wideband, male-female, music-speech-silence, etc.) by using training data. In yet another example, the audio stream is segmented by evaluating a predetermined metric between two neighboring audio segments, etc.

Many currently existing scene segmentation and speaker segmentation techniques may use Hidden Markov Models (HMM) to perform scene segmentation and/or speaker segmentation. HMM is a statistical Markov model in which the system being modeled is assumed to be a Markov process with unobserved (i.e., hidden) states. Typically, in a HMM, the probability of occupying a state is determined solely by the preceding state (and not the states that came earlier than the preceding state). For example, assume a video sequence has two underlying states: state 1 with a speaker, and state 2 without a speaker. If one frame contains a speaker (i.e., frame in state 1), it is highly likely that the next frame also contains a speaker (i.e., next frame also in state 1) because of strong frame-to-frame dependence. On the other hand, a frame without a speaker (i.e., frame in state 2) is more likely to be followed by another frame without a speaker (i.e., frame also in state 2). Such dependencies between states characterize an HMM.

The state sequence in an HMM cannot be observed directly, but rather may be observed through a sequence of observation vectors (e.g., video observables and audio observables). Each observation vector corresponds to an underlying state with an associated probability distribution. In the HMM process, an initial HMM may be created manually (or using off-line training sequences) and a decoding algorithm (such as Bahl, Cocke, Jelinek and Raviv (BOR) algorithm, or the Viterbi algorithm) to discover the underlying state sequence given the observed data during a period of time.

However, there are no techniques currently to improve accuracy of scene segmentation using speaker segmentation data and vice versa. Some Telepresence systems may currently implement techniques to improve face recognition using scene information. For example, the range of possible people present in a Telepresence recording may be narrowed through knowledge of which Telepresence endpoints are present in the call. The information (e.g., range of possible people present in a Telepresence meeting) is provided through protocols used in Telepresence for call signaling and control. Given that endpoints are typically unique to a scene (with the exception of mobile clients such as Cisco® Movi client) knowing which endpoint is in the call is analogous to knowing what scene is present. However, when communicating through a bridge, protocols required to indicate which endpoint is currently speaking (or ‘has the floor’), although standardized, are not necessarily implemented, and such information may not be present in the recording. Additionally, relying on this information precludes such systems from operating on videos that were not captured using Telepresence endpoints.

A system for creating customized on-demand video reports in a network environment, illustrated in FIG. 1, can resolve many of these issues. Embodiments of system 10 may exploit dependencies between a given scene and a set of speakers to improve the scene recognition and speaker identification performance of scene segmentation algorithms and speaker segmentation algorithms (e.g., simultaneously). Stated in different terms, one premise of the architecture of system 10 is that there exists a correlation between a given scene and a speaker (or set of speakers). The framework of system 10 can exploit this premise to improve both the scene recognition and the speaker identification performance (at the same time) by utilizing the correlations that exist between the two. Furthermore, the framework can be viewed as somewhat recursive, whereby a processor may operate on a video stream with spare background cycles to improve the performance (e.g., for both scene segmentation and speaker segmentation) over time. The media stream may be obtained from one or more media files in media source 12. Moreover, embodiments of system 10 can operate on videos and audios captured from any capture system (e.g., Telepresence recordings, home videos, television broadcasts, movies, etc.).

In one example embodiment, there may be a one-to-one correspondence between a scene and a speaker in a set of media files (e.g., in media files of Telepresence meeting recordings). In such cases, each application of a speaker segmentation algorithm may directly imply corresponding scene segmentation and vice versa. On the other end, typical videos may include at least one scene and a few speakers (per scene). A statistical model may be formulated that relates the probability of a speaker for each scene and vice versa. Such a statistical model may improve speaker segmentation, as there may exist dependencies between specific scenes (e.g., room locations, background, etc.) and speakers even in cases with not more than a single scene.

In operation, the architecture of system 10 may be configured to analyze video/audio data from one or more media files in media source 12 to determine scene changes, and order scenes into a scene sequence using suitable scene segmentation algorithms. As used herein, the term “video/audio” data is meant to encompass video data, or audio data, or a combination of video and audio data. In one embodiment, video/audio data from one or more media files in media source 12 may also be analyzed to determine the number of speakers, and the speakers may be ordered into a speaker sequence using suitable speaker segmentation algorithms.

According to embodiments of system 10, the scene sequence obtained from scene segmentation algorithms may be used to improve the accuracy of the speaker sequence obtained from speaker segmentation algorithms. Likewise, the speaker sequence obtained from speaker segmentation algorithms may be used to improve the accuracy of the scene sequence obtained from scene segmentation algorithms. Thus, embodiments of system 10 may determine a scene sequence from the video/audio data of one or more media files in a network environment, determine a speaker sequence from the video/audio data of the media files, iteratively update the scene sequence based on the speaker sequence, and iteratively update the speaker sequence based on the scene sequence. In some embodiments, a plurality of scenes and a plurality of speakers may be detected in the media files. In one embodiment, the media files may be obtained from search query 30.

The video/audio data may be suitably modeled as an HMM with hidden states corresponding to different scenes and the audio data may be suitably modeled as another HMM with hidden states corresponding to different speakers. In other embodiments, the video/audio data may be modeled together. For example, boosting and bagging may be used to train many simple classifiers to detect one feature. The classifiers can incorporate stochastic weighted viterbi to model audio and video streams together. The output of the classifiers can be combined using voting or other methods (e.g., consensual neural network).

The scene sequence may be updated by computing a conditional probability of the scene sequence given the speaker sequence, estimating a new scene sequence based on the conditional probability of the scene sequence given the speaker sequence, comparing the new scene sequence with the previously determined scene sequence, and updating the previously determined scene sequence to the new scene sequence if there is a difference between the new scene sequence and the previously determined scene sequence.

Computing the conditional probability can include iteratively applying at least one dependency between scenes and speakers in the media files. An initial conditional probability of the scene sequence given the speaker sequence may be estimated through off-line training sequences using supervised learning algorithms. “Off-line training sequences” may include example scene sequences and speaker sequences that are not related to the media files being analyzed from media source 12. The conditional probabilities could also be estimated after a first pass of speaker and scene segmentation, and the conditional probabilities can themselves be refined after each re-estimation of the scene and speaker segmentations.

Updating the speaker sequence can include computing a conditional probability of the speaker sequence given the scene sequence, estimating a new speaker sequence based on the conditional probability of the speaker sequence given the scene sequence, comparing the new speaker sequence with the previously determined speaker sequence, and updating the previously determined speaker sequence to the new speaker sequence if there is a difference between the new speaker sequence and the previously determined speaker sequence. Computing the conditional probability of the speaker sequence given the scene sequence can include iteratively applying at least one dependency between scenes and speakers in the media file. In some embodiments, the at least one dependency may be identical to the dependency applied for determining scene sequences. In other embodiments, the dependencies that are applied on computations for speaker sequences and scene sequences may be different. An initial conditional probability of the speaker sequence given the scene sequence may be estimated through off-line training sequences comprising supervised learning algorithms also. The conditional probabilities could also be estimated after a first pass of speaker and scene segmentation, and the conditional probabilities can themselves be refined after each re-estimation of the scene and speaker segmentations.

Turning to the infrastructure of FIG. 1, applications delivery module 14 may include suitable components for video/audio storage, video/audio processing, and information retrieval functionalities. Examples of such components include servers with repository services that store digital content, indexing services that allow searches, client/server systems, disks, image processing systems, etc. In some embodiments, components of applications delivery module 14 may be located on a single network element; in other embodiments, components of applications delivery module 14 may be located on more than one network element, dispersed across various networks. As used herein in this Specification, the term “network element” is meant to encompass network appliances, servers, routers, switches, gateways, bridges, loadbalancers, firewalls, processors, modules, or any other suitable device, proprietary component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

Applications delivery module 14 may support multi-media content, enable link representation to local/external objects, support advanced search and retrieval, support annotation of existing information, etc. Search engine 20 may be configured to accept search query 30, perform one or more searches of video content stored in applications delivery module 14 or in media source 12, and provide the search results to analysis engine 22. Analysis engine 22 may suitably cooperate with scene segmentation module 16 and speaker segmentation module 18 to generate report 24 including the search results from search query 30. Report 24 may be stored in applications delivery module 14, or suitably displayed to user 32 via user interface 28, or saved into an external storage device such as a disk, hard drive, memory stick, etc. Applications delivery module 14 may facilitate integrating image and video processing and understanding, speech recognition, distributed data systems, networks and human-computer interactions in a comprehensive manner. Content based indexing and retrieval algorithms may be implemented in various embodiments of application delivery module 14 to enable user 32 to interact with videos from media source 12.

Turning to front end 26 (through which user 32 can interact with elements of system 10), user interface 28 may be implemented using any suitable means for interaction such as a graphical user interface (GUI), a command line interface (CLI), web-based user interfaces (WUI), touch-screens, keystrokes, touch pads, gesture interfaces, display monitors, etc. User interface 28 may include hardware (e.g., monitor; display screen; keyboard; etc.) and software components (e.g., GUI; CLI; etc.). User interface 28 may provide a means for input (e.g., allowing user 32 to manipulate system 10) and output (e.g., allowing user 32 to view report 24, among other uses). In various embodiments, search query 30 may allow user 32 to input text strings, matching conditions, rules, etc. For example, search query 30 may be populated using a customized form, for example, for inserting scene names, identifiers, etc. and speaker names. In another example, search query 30 may be populated using a natural language search term.

According to embodiments of the present disclosure, elements of system 10 may represent a series of points or nodes of interconnected communication paths for receiving and transmitting packets of information, which propagate through system 10. Elements of system 10 may include network elements (not shown) that offer a communicative interface between servers (and/or users) and may be any local area network (LAN), a wireless LAN (WLAN), a metropolitan area network (MAN), a virtual LAN (VLAN), a virtual private network (VPN), a wide area network (WAN), or any other appropriate architecture or system that facilitates communications in a network environment. In other embodiments, substantially all elements of system 10 may be located on one physical device (e.g., camera, server, media processing equipment, etc.) that is configured with appropriate interfaces and computing capabilities to perform the operations described herein.

Elements of FIG. 1 may be coupled to one another through one or more interfaces employing any suitable connection (wired or wireless), which provides a viable pathway for electronic communications. For example, wired connections may be implemented through any physical medium such as conductive wires, optical fiber cables, metal traces on semiconductor chips, etc. Additionally, any one or more of these elements of FIG. 1 may be combined or removed from the architecture based on particular configuration needs. System 10 may include a configuration capable of transmission control protocol/Internet protocol (TCP/IP) communications for the electronic transmission or reception of packets in a network. System 10 may also operate in conjunction with a user datagram protocol/IP (UDP/IP) or any other suitable protocol, where appropriate and based on particular needs.

In various embodiments, media source 12 may include any suitable repository for storing media files, including web server, enterprise server, hard disk drives, camcorder storage devices, video cards, etc. Media files may be stored in any file format, including Moving Pictures Experts Group (MPEG), Apple Quick Time Movie (MOV), Windows Media Video (WMV), Real Media (RM), etc. Suitable file format conversion mechanisms, analog-to-digital conversions, etc. and other elements to facilitate accessing media files may also be implemented in media source 12 within the broad scope of the present disclosure.

In various embodiments, elements of system 10 may be implemented as a stand-alone solution with associated databases for video sources 12; processors and memory for executing instructions associated with the various elements (e.g., scene segmentation module 16, speaker segmentation module 18, etc.); etc. User 32 may access the stand-alone solution to initiate activities associated therewith. In other embodiments, elements of system 10 may be dispersed across various networks.

For example, media source 12 may be a web server located in an Internet cloud; applications delivery module 14 may be implemented on one or more enterprise servers; and front end 26 may be implemented on a user device (e.g., mobile devices, personal computers, electronic devices, and any other device, component, element, or object operable by a user and capable of initiating voice, audio, or video, exchanges within system 10). User 32 may run an application on the user device, which may bring up user interface 28, through which user 32 may initiate the activities associated with system 10. Myriad such implementation scenarios are possible within the broad scope of the present disclosure. Embodiments of system 10 may leverage existing video repository systems (e.g., Cisco® Show and Share, YouTube, etc.), incorporate existing media/video tagging and speaker identification capability of existing devices (e.g., as provided in Cisco MXE3500 Media Experience Engine) and add features to allow users (e.g., user 32) to search media files for particular scenes or speakers.

In other embodiments, speakers may further be discerned by an apparent multi-channel spatial position of a voice source in a multi-channel audio stream. In addition to trying to correlate the outputs of speaker identification and scene identification, the apparent multi-channel spatial position (e.g., stereo, or four-channel in the case of some audio products like Cisco® CTS3K) of the voice source may be used to determine the speakers, providing additional accuracy gain (for example, in Telepresence originated content).

Turning to FIG. 2, FIG. 2 is a simplified block diagram illustrating additional details of system 10. Video data 40 from media source 12 may be fed to scene segmentation module 16 in applications delivery module 14. Scene segmentation module 16 may detect scenes in video data 40, and determine an approximate scene sequence. The approximate scene sequence may be fed to analysis engine 22. Audio data 42 from media source 12 may be fed to speaker segmentation module 18. Speaker segmentation module 18 may detect speakers in audio data 42, and determine an approximate speaker sequence. The approximate speaker sequence may also be fed to analysis engine 22.

Analysis engine 22 may include a probability computation module 44 and a database of conditional probability models 46. Analysis engine 22 may use the approximate scene sequence information from scene segmentation module 16 and approximate speaker sequence information from speaker segmentation module 18 to update probability calculations of scene sequences and speaker sequences. In statistical algorithms used by embodiments of system 10, probabilities may be passed between an algorithm used to process speech (e.g., speaker segmentation algorithm) and an algorithm used to process video (e.g., scene segmentation algorithm) to enhance the performance of each algorithm. One or more methods in which probabilities may be passed between the two algorithms may be used herein, with the underlying aspect of all the implemented methods being a dependency between the states of each algorithm that may be exploited in the decoding of both speech and video to iteratively improve both.

In example embodiments, video data 40, denoted as “s,” may be modeled as an HMM with hidden states corresponding to different scenes. Similarly, for speaker segmentation, audio data 42, denoted as “x,” can be modeled by an HMM with hidden states corresponding to speakers. The relationship between the states of the HMM for the video and the states of the HMM for the audio may be modeled as probability distributions P(w|q) and P(q|w) (i.e., probability of a speaker sequence given a scene sequence and probability of a scene sequence given a speaker sequence, respectively). After modeling the relationship between states, an estimate ŵ of the speaker sequence may be appropriately computed as the speaker sequence for which the function describing the probability of occurrence of a particular speaker sequence w, particular scene sequence q, video data 40 (i.e., “s”) and audio data 42 (i.e., “x”) attains its largest value. Mathematically, ŵ may be expressed as:

$$\begin{matrix}\hat{w} = {arg max}_{w} P ( w , q , x , s ) \\ = {arg max}_{w} P ( w , x \vert q , s ) P ( q , s )\end{matrix}$$

Because P(q,s) is independent of w:

$$\hat{w} = {arg max}_{w} P ( w , x \vert q , s )$$

Assuming that w and x do not depend on s (i.e., speaker sequence and audio data 42 do not depend on video data 40):

$$\begin{matrix}\hat{w} = {arg max}_{w} P ( w , x \vert q ) \\ = {arg max}_{w} P ( x \vert w , q , ) P ( w \vert q )\end{matrix}$$

Assuming that audio sequence does not depend on the scene sequence, P(x|w,q) is the same as P(x|w). Thus:

$$\hat{w} = {arg max}_{w} P ( x \vert w ) P ( w \vert q )$$

Similarly, an estimate \hat{q} of the scene sequence may be appropriately obtained from the following optimization equations:

$$\hat{q} = {arg max}_{q} P ( w , q , x , s ) = {arg max}_{q} P ( s \vert q ) P ( q \vert w )$$

There are many dynamic programming methods for solving the above optimization equations. In embodiments of the present disclosure, the solution may be iteratively improved by passing the estimated probabilities, P(w|q) and P(q|w), between the algorithms for ŵ and \hat{q} to improve the performance with each decoding. In some embodiments, BCJR algorithm may be used for solving the optimization equation (e.g., BCJR algorithm may also produce probabilistic outputs that may be passed between algorithms).

Probabilities P(q|w) and P(w|q) may be initially estimated through various off-line training sequences. In some embodiments, the initial probabilities may be estimated through off-line training sequences using supervised learning algorithms, where the speakers and scenes can be known a priori. As used herein, “supervised learning algorithms” encompass machine learning tasks of inferring a function from supervised (e.g., labeled) training data. The training data can consist of a set of training examples of scene sequences and corresponding speaker sequences. The supervised learning algorithm analyzes the training data and produces an inferred function, which should predict the correct output value for any valid input object.

After the initial probabilities are established, future refinements may be done through unsupervised learning algorithms (e.g., algorithms that seek to find hidden structure such as clusters, in unlabeled data). For example, an initial estimate of P(q|w) and P(w|q) based on an initial speaker and scene segmentation can be used to improve the speaker and scene segmentations, which can then be used to re-estimate the conditional probabilities. Embodiments of system 10 may cluster scenes and speakers using unsupervised learning algorithms and compute relevant probabilities of occurrence of the clusters. The probabilities may be stored in conditional probability models 46, which may be updated at regular intervals. Applications delivery module 14 may utilize a processor 48 and a memory element 50 for performing operations as described herein. Analysis engine 22 may finally converge iterations from scene segmentation algorithms and speaker segmentation algorithms to a scene sequence 52 and a speaker sequence 54. In various embodiments, scene sequence 52 may comprise a plurality of scenes arranged in a chronological order; speaker sequence 54 may comprise a plurality of speakers arranged in a chronological order.

In various embodiments, scene sequence 52 and speaker sequence 54 may be used to generate report 24 in response to search query 30. For example, report 24 may include scenes and speakers searched by user 32 using search query 30. The scenes and speakers may be arranged in report 24 according to scene sequence 52 and speaker sequence 54. In various embodiments, user 32 may be provided with options to click through to particular scenes of interest, or speakers of interest, as the case may be. Because each scene sequence 52 and speaker sequence 54 may include scenes tagged with scene identifiers, and speakers tagged with speaker identifiers, respectively, searching for particular scenes and/or speakers in report 24 may be effected easily.

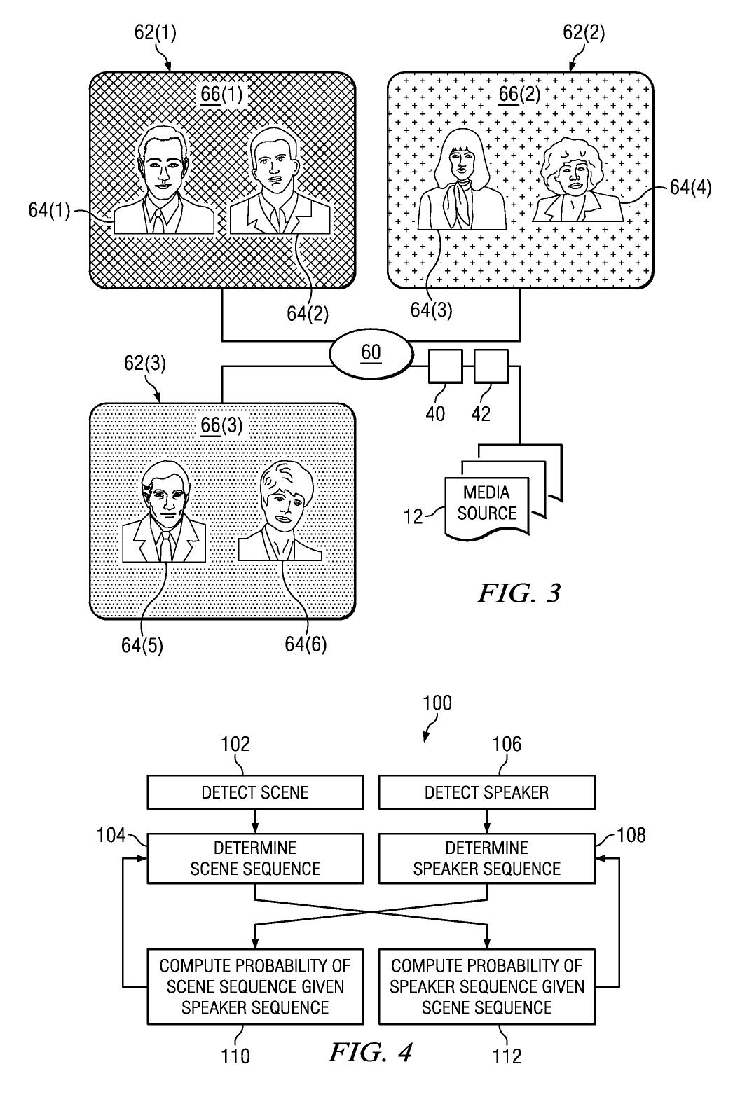

Turning to FIG. 3, FIG. 3 is an example operation of an embodiment of system 10. Assume, merely for the sake of description, and not as a limitation, that a video conference 60 includes endpoints 62(1)-62(3), with speakers 64(1)-64(6) in separate locations (e.g., conference rooms) having respective backgrounds 66(1)-66(3). Endpoints 62(1)-62(3) may be spatially separated and even geographically remote from each other. For example, endpoint 62(1) may be located in New Zealand, and endpoints 62(2) and 62(3) may be located in the United States. More particularly, endpoint 62(1) may include speakers 64(1) and 64(2) in a location with background 66(1); endpoint 62(2) may include speakers 64(3) and 64(4) in another location with background 66(2); and endpoint 62(3) may include speakers 64(5) and 64(6) in yet another location with background 66(3). Video conference 60 may be recorded into a media file comprising video data 40 and audio data 42, which may be saved to media source 12 in a suitable format. Video data 40 and audio data 42 from media source 12 may be analyzed suitably by components of system 10.

Each speaker 64(1)-64(6) may be recognized by corresponding audio qualities of the speaker's voice, for example, frequency, bandwidth, etc. Speakers may also be recognized by classes (e.g., male versus female). Assume merely for descriptive purposes that speakers 64(1), 64(2), and 64(5) are male, whereas speakers 64(3), 64(4), and 64(6) are female. Suitable speaker segmentation algorithms (e.g., associated with speaker segmentation module 18) may easily distinguish between speaker 64(1), who is male, and speaker 64(3), who is female; whereas, distinguishing between speaker 64(1) and 64(5), who are both male, or between 64(3) and 64(6), who are both female, may be more error prone.

Scenes associated with video conference 60 may include discrete scenes of endpoints 62(1), 62(2), and 62(3) identified by suitable features such as the respective backgrounds. Thus, a scene 1 may be identified by background 66(1), a scene 2 may be identified by background 66(2) and a scene 3 may be identified by background 66(3). Assume, merely for descriptive purposes, that background 66(1) is a white background; background 66(2) is an orange background; and background 66(3) is a red background. Suitable scene segmentation algorithms (e.g., associated with scene segmentation module 16) may easily distinguish some scene features from other contrasting scene features (e.g., white background from orange background), but may be error prone when distinguishing similar looking features (e.g., orange and red backgrounds).

According to embodiments of system 10, errors in scene segmentation and speaker segmentation may be reduced by using dependencies between scenes and speakers to improve the accuracy of scene segmentation and speaker segmentation. For example, the way video conference 60 is recorded may impose certain constraints on scene and speaker segmentation. During video conference 60, each speaker 64 may speak in turn in a conversational style (e.g., asking question, responding with answer, making a comment, etc.). Thus, at any instant in time, only one speaker 64 may be speaking; thereby audio data 42 may include an audio track of just that one speaker 64 at that instant in time.

There may be some instances when more than one speaker speaks; however, such instances are assumed likely to be minimal. Such an assumption may hold true for most conversational style type of situations in videos such as in movies (where actors converse with each other and not more than one actor is speaking at any instant), television shows, news broadcasts, etc. Additionally, at any instant in time, only one scene may be included in video data 40; conversely, no two scenes may occur simultaneously in video data 40. If video conference 60 is recorded to show the active speaker at any instant in time, there may be a one-to-one correspondence between the scenes and speakers. Thus, each speaker may be present in only one scene, and each scene may be associated with correspondingly unique speakers.

For example, assume the following sequence of speakers in video conference 60: speaker 64(1) speaks first, followed by speaker 64(2), then by speaker 64(3), followed by speaker 64(6) and the last speaker is speaker 64(4). The speaker sequence may be denoted by w={64(1), 64(2), 64(3), 64(6), 64(4)}. Because video conference 60 is recorded to show the active speaker at any instant in time, the sequence of scenes should be: scene 1 (identified by background 66(1)), followed by scene 1 again, followed by scene 2 (identified by background 66(2)), then by scene 3 and the last scene is scene 2. The scene sequence may be denoted as q={scene 1, scene 1, scene 2, scene 3, scene 2}.

Probabilities of occurrence of certain audio data 42 and/or video data 40 may be higher or lower relative to other audio and video data. For example, the speaker segmentation algorithm may not differentiate between speakers 64(5) and 64(2), and between speakers 64(6) and 64(4). Thus, the speaker segmentation algorithm may have high confidence about the first and fourth speakers, but not as to the other speakers. The speaker segmentation algorithm may consequently provide a first estimate for speaker sequence w₁ that is not an accurate speaker sequence (e.g., w₁={64(1), 64(5), 64(3), 64(6), 64(6)}). Likewise, the scene segmentation algorithm may not differentiate between scene 2 and scene 3 when they occur one after the other, but may have high confidence about the first, second, and fifth scenes, to provides a first estimate of scene sequence q₁ that is not an accurate scene sequence (e.g., q₁={scene 1, scene 1, scene 2, scene 2, scene 2}).

Given speaker sequence w₁, and high confidence levels in first and fourth speakers, the probability of scene sequence given speaker sequence may be computed (e.g., P(q|w) may be a maximum for an estimated q₁*|w₁={scene 1, scene 3, scene 2, scene 3, scene 3}). Likewise, given scene sequence q₁, and the high confidence levels about the first, second, and fifth scenes, and further speaker segmentation iterations to distinguish between speakers in a particular scene, the probability of speaker sequence given scene sequence may be computed (e.g., P(w|q) may be a maximum for an estimated q₁*|q₁={64(1), 64(2), 64(3), 64(4), 64(4)}). In some embodiments, q₁* may be compared to q₁, and w₁* may be compared to w₁, and if there is a difference, further iterations may be in order.

For example, taking into account the high confidence about particular video data 40 (e.g., the first, second, and fifth scenes), a second scene sequence q₂ may be obtained (e.g., q₂={scene 1, scene 1, scene 2, scene 3, scene 2}); taking into account the high confidence levels in particular audio data 42 (e.g., first and fourth speakers), a second speaker sequence w2 may be obtained (e.g., w₂={64(1), 64(2), 64(3), 64(6), 64(4)}). Given the second speaker sequence w₂, and associated confidence levels, the probability of scene sequence given the second speaker sequence may be computed (e.g., q₂*|w₂={scene 1, scene 1, scene 2, scene 3, scene 2}). Likewise, given the second scene sequence q₂, associated confidence levels, and further speaker segmentation iterations to distinguish between speakers in a particular scenes, the probability of speaker sequence given the second scene sequence may be computed (e.g., w₂*|q₂={64(1), 64(2), 64(3), 64(6), 64(4)}).

In one embodiment, when the newly estimated scene sequence and speaker sequence are the same as the previously estimated respective scene sequence and speaker sequence, the iterations may be stopped. Various factors may impact the number of iterations. For example, different confidence levels for speakers and different confidence levels for scenes may increase or decrease the number of iterations to converge to an optimum solution. In another embodiment, a fixed number of iterations may be run, and the final scene sequence and speaker sequence estimated from the final iteration may be used for generating report 24. Thus, conditional probability models P(q|w) and P(w|q) may be suitably used iteratively to reduce errors in scene segmentation and speaker segmentation algorithms.

Although the example herein describes certain particular constraints such as speakers speaking in a conversational style, embodiments of system 10 may be applied to other constraints as well, for example, having multiple speakers speak at any instant in time. Further, any other types of constraints (e.g., visual, auditory, etc.) may be applied without changing the broad scope of the present disclosure. Embodiments of system 10 may suitably use the constraints, of whatever nature, and of any number, to develop dependencies between scenes and speakers, and compute respective probability distributions for scene sequences given a particular speaker sequence and vice versa.

Turning to FIG. 4, FIG. 4 is a simplified flow diagram of example operational activities that may be associated with embodiments of system 10. Operations 100 may include 102, when a scene is detected from video data 40. In some embodiments, the scene may be detected using appropriate scene identifiers. In other embodiments, the scene may be detected using timestamps of the constituent shots. In yet other embodiments, the scene may be detected by locating the start and end of each shot, and combining the shots based on content to obtain the start and end points of each scene. For example, shots may be detected from metadata of underlying video data. In another example, shots may be detected by identifying sharp transitions between shots based on various video features such as change in brightness, pixel values, and color distribution from frame to frame, etc. Shots may then be arranged into the scene by clustering shots according to suitable algorithms such as force competition, best-first model merging, etc.

In various embodiments, suitable scene segmentation algorithms may be used to recognize a scene change. Whenever there is a scene change, the scene recognition algorithm, which looks for features that describe the scene, may be applied. All the scenes that have been previously analyzed may be compared to the current scene being analyzed. A matching operation may be performed to determine if the current scene is a new scene or part of a previously analyzed scene. If the current scene is a new scene, a new scene identifier may be assigned to the current scene; otherwise, a previously assigned scene identifier may be applied to the scene. At 104, the detected scenes may be combined to form scene sequence 52.

At 106, audio data 42 may be analyzed to detect speakers, for example, by identifying audio regions of the same gender, same bandwidth, etc. In each of these regions, the audio data may be divided into uniform segments of several lengths, and these segments may be clustered in a suitable manner. Different features and cost functions may be used to iteratively arrive at different clusters. Computations can be stopped at a suitable point, for example, when further iterations impermissibly merge two disparate clusters. Each cluster may represent a different speaker. At 108, the speakers may be ordered into speaker sequence 54.

At 110, a probability of scene sequence given speaker sequence (P(q|w)) may be computed. The computed probability of scene sequence given speaker sequence may be used to improve the accuracy of determining scene sequence 52 at 104. At 112, a probability of speaker sequence given scene sequence (P(w|q)) may be computed. The computed probability of speaker sequence given scene sequence may be used to improve the accuracy of determining speaker sequence 54 at 108. The process may be recursively repeated and multiple iterations performed to converge to optimum scene sequence 52 and speaker sequence 54.

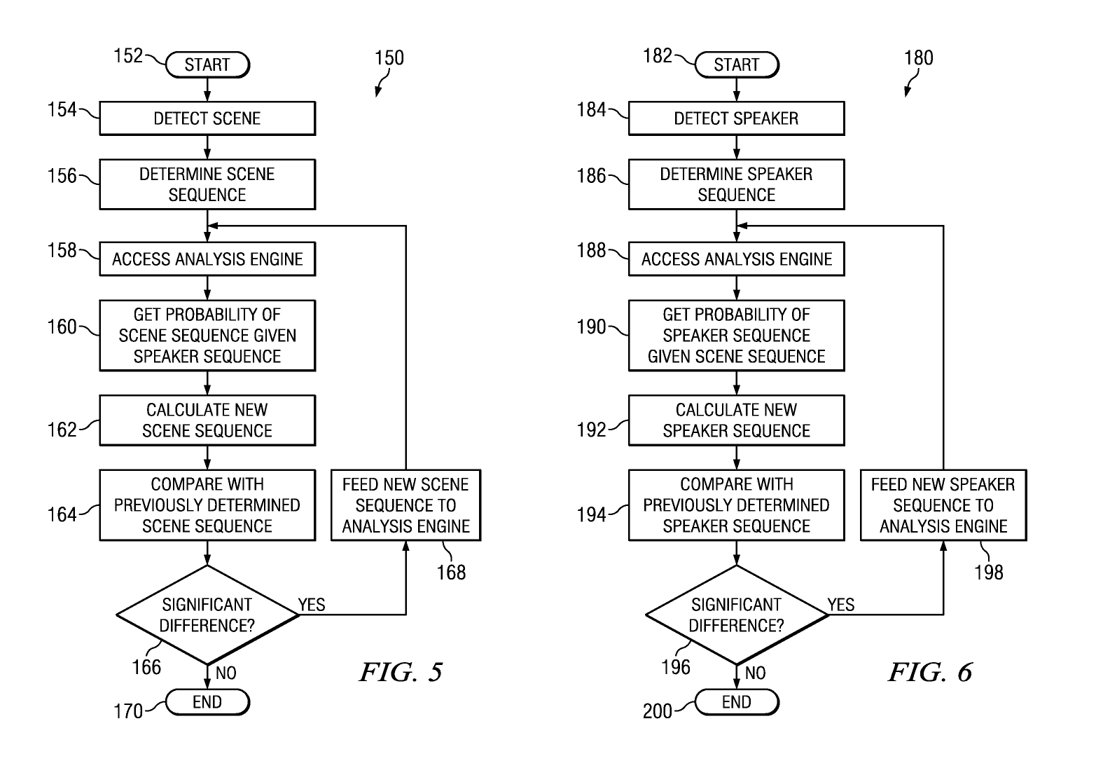

Turning to FIG. 5, FIG. 5 is a flow diagram illustrating example operational steps that may be associated with embodiments of the present disclosure. Operations 150 may begin at 152, when video data 40 is input into scene segmentation module 16. At 154, scenes may be detected using appropriate scene segmentation algorithms. At 156, an approximate scene sequence may be determined. At 158, analysis engine 22 may be accessed, and probability of a scene sequence given a particular speaker sequence may be retrieved at 160. For an initial iteration, such conditional probability models may be obtained through suitable supervised training algorithms. Data for training can consist of features computed for a collection of video (not necessarily the video being analyzed), that is pre-labeled to include features such as shot transitions, environmental objects, etc. Data for training can additionally consist of features computed for a collection of audio (not necessarily the audio being analyzed), that is pre-labeled to include distinguish speakers based on gender, or bandwidth, etc. A supervised learning algorithm may be suitably applied to get an initial conditional probability model for scene sequence given a particular speaker sequence.

At 162, a new scene sequence may be calculated based on the retrieved conditional probability model. At 164, the new scene sequence may be compared to the previously determined approximate scene sequence. If there is a significant difference, for example, in error markers (e.g., scene boundaries), the new scene sequence may be fed to analysis engine at 168. In subsequent iterations, probability of the scene sequence given a particular speaker sequence may be obtained from substantially parallel processing of speaker sequence 54 by suitable speaker segmentation algorithms. In some embodiments, instead of comparing with the previously determined approximate scene sequence, a certain number of iterations may be run. The operations end at 170, when an optimum scene sequence 52 is obtained.

Turning to FIG. 6, FIG. 6 is a flow diagram illustrating example operational steps that may be associated with embodiments of the present disclosure. Operations 180 may begin at 182, when audio data 42 is input into speaker segmentation module 18. At 184, speakers may be detected using appropriate scene segmentation algorithms. At 186, an approximate speaker sequence may be determined. At 188, analysis engine 22 may be accessed, and probability of speaker sequence given a particular scene sequence may be retrieved at 190. For an initial iteration, such conditional probability models may be obtained through suitable training algorithms as discussed previously. The supervised learning algorithm may be suitably applied to get an initial conditional probability model for speaker sequence given a scene sequence.

At 192, a new speaker sequence may be calculated based on the retrieved conditional probability model. At 194, the new speaker sequence may be compared to the previously determined approximate speaker sequence. If there is a significant difference, for example, in error markers (e.g., speaker identities), the new speaker sequence may be fed to analysis engine at 198. In subsequent iterations, probability of a speaker sequence given a particular scene sequence may be obtained from substantially parallel processing of scene sequence 52 by suitable scene segmentation algorithms. In some embodiments, instead of comparing with the previously determined speaker sequence, a certain number of iterations may be run. The operations end at 200, when an optimum speaker sequence is obtained.

In example embodiments, at least some portions of the activities outlined herein may be implemented in non-transitory logic (i.e., software) provisioned in, for example, nodes embodying various elements of system 10. This can include one or more instances of applications delivery module 14, or front end 26 being provisioned in various locations of the network. In some embodiments, one or more of these features may be implemented in hardware, provided external to these elements, or consolidated in any appropriate manner to achieve the intended functionality. Applications delivery module 14, and front end 26 may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, components of system 10 described and shown herein may also include suitable interfaces for receiving, transmitting, and/or otherwise communicating data or information in a network environment. Additionally, some of the processors and memory associated with the various nodes may be removed, or otherwise consolidated such that a single processor and a single memory location are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 50) can store data used for the operations described herein. This includes the memory element being able to store instructions (e.g., software, logic, code, etc.) that are executed to carry out the activities described in this Specification. A processor can execute any type of instructions associated with the data to achieve the operations detailed herein in this Specification. In one example, one or more processors (e.g., processor 48) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

Components in system 10 can include one or more memory elements (e.g., memory element 50) for storing information to be used in achieving operations as outlined herein. These devices may further keep information in any suitable type of memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

Note that with the numerous examples provided herein, interaction may be described in terms of two, three, four, or more nodes. However, this has been done for purposes of clarity and example only. It should be appreciated that the system can be consolidated in any suitable manner. Along similar design alternatives, any of the illustrated computers, modules, components, and elements of the FIGURES may be combined in various possible configurations, all of which are clearly within the broad scope of this Specification. In certain cases, it may be easier to describe one or more of the functionalities of a given set of flows by only referencing a limited number of nodes. It should be appreciated that system 10 of the FIGURES and its teachings are readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Furthermore, the words “optimize,” “optimization,” “optimum,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, system 10 may be applicable to other exchanges or routing protocols in which packets are exchanged in order to provide mobility data, connectivity parameters, access management, etc. Moreover, although system 10 has been illustrated with reference to particular elements and operations that facilitate the communication process, these elements and operations may be replaced by any suitable architecture or process that achieves the intended functionality of system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a media file that includes video data and audio data;
determining an initial scene sequence in the media file;
determining an initial speaker sequence in the media file; and
updating a selected one of the initial scene sequence and the initial speaker sequence in order to generate an updated scene sequence and an updated speaker sequence respectively, wherein the initial scene sequence is updated based on the initial speaker sequence, and wherein the initial speaker sequence is updated based on the initial scene sequence.

2. The method of claim 1, further comprising:
detecting a plurality of scenes and a plurality of speakers in the media file.

3. The method of claim 1, further comprising:
modeling the video data as a hidden Markov Model (HMM) with hidden states corresponding to different scenes of the media file; and
modeling the audio data as another HMM with hidden states corresponding to different speakers of the media file.

4. The method of claim 1, wherein updating the initial scene sequence comprises:
computing a conditional probability of the initial scene sequence given the initial speaker sequence;
estimating the updated scene sequence based on at least the conditional probability of the initial scene sequence given the initial speaker sequence;
comparing the updated scene sequence with the initial scene sequence; and
updating the initial determined scene sequence to the updated scene sequence if there is a difference between the updated scene sequence and the initial scene sequence.

5. The method of claim 1, further comprising:
estimating an initial conditional probability of the initial scene sequence given the initial speaker sequence through off-line training sequences using supervised learning algorithms.

6. The method of claim 1, further comprising:
estimating an initial conditional probability of the initial scene sequence given the initial speaker sequence through off-line training sequences using unsupervised learning algorithms.

7. The method of claim 1, wherein updating the initial speaker sequence comprises:
computing a conditional probability of the initial speaker sequence given the initial scene sequence;
estimating the updated speaker sequence based on at least the conditional probability of the initial speaker sequence given the initial scene sequence;
comparing the updated speaker sequence with the initial speaker sequence; and
updating the initial determined speaker sequence to the updated speaker sequence if there is a difference between the updated speaker sequence and the initial speaker sequence.

8. The method of claim 1, further comprising:
estimating an initial conditional probability of the initial speaker sequence given the initial scene sequence through off-line training sequences using supervised learning algorithms.

9. The method of claim 1, further comprising:
estimating an initial conditional probability of the initial speaker sequence given the initial scene sequence through off-line training sequences using unsupervised learning algorithms.

10. An apparatus, comprising:
a memory configured to store data; and
a processor that executes instructions associated with the data, wherein the processor and the memory cooperate such that the apparatus is configured for:
receiving a media file that includes video data and audio data;
determining an initial scene sequence in the media file;
determining an initial speaker sequence in the media file; and
updating a selected one of the initial scene sequence and the initial speaker sequence in order to generate an updated scene sequence and an updated speaker sequence respectively, wherein the initial scene sequence is updated based on the initial speaker sequence, and wherein the initial speaker sequence is updated based on the initial scene sequence.

11. The apparatus of claim 10, wherein the apparatus is further configured for:
modeling the video data as a HMM with hidden states corresponding to different scenes of the media file; and
modeling the audio data as another HMM with hidden states corresponding to different speakers of the media file.

12. The apparatus of claim 10, wherein updating the scene sequence comprises:
computing a conditional probability of the initial scene sequence given the initial speaker sequence;
estimating the updated scene sequence based on at least the conditional probability of the initial scene sequence given the initial speaker sequence;
comparing the updated scene sequence with the initial scene sequence; and
updating the initial determined scene sequence to the updated scene sequence if there is a difference between the updated scene sequence and the initial scene sequence.

13. The apparatus of claim 10, wherein the apparatus is further configured for:
estimating an initial conditional probability of the initial scene sequence given the initial speaker sequence through off-line training sequences using supervised learning algorithms.

14. The apparatus of claim 10, wherein updating the speaker sequence comprises:
computing a conditional probability of the initial speaker sequence given the initial scene sequence;
estimating the updated speaker sequence based on at least the conditional probability of the initial speaker sequence given the initial scene sequence;
comparing the updated speaker sequence with the initial speaker sequence; and
updating the initial determined speaker sequence to the updated speaker sequence if there is a difference between the updated speaker sequence and the initial speaker sequence.

15. The apparatus of claim 10, wherein the apparatus is further configured for:
estimating an initial conditional probability of the initial speaker sequence given the initial scene sequence through off-line training sequences using supervised learning algorithms.

16. Logic encoded in non-transitory media that includes code for execution and when executed by a processor is operable to perform operations comprising:
receiving a media file that includes video data and audio data;
determining an initial scene sequence in the media file;
determining an initial speaker sequence in the media file; and
updating a selected one of the initial scene sequence and the initial speaker sequence in order to generate an updated scene sequence and an updated speaker sequence respectively, wherein the initial scene sequence is updated based on the initial speaker sequence, and wherein the initial speaker sequence is updated based on the initial scene sequence.

17. The logic of claim 16, wherein the updating the scene sequence comprises:
computing a conditional probability of the initial scene sequence given the initial speaker sequence;
estimating the updated scene sequence based on at least the conditional probability of the initial scene sequence given the initial speaker sequence;
comparing the updated scene sequence with the initial scene sequence; and
updating the initial determined scene sequence to the updated scene sequence if there is a difference between the updated scene sequence and the initial scene sequence.

18. The logic of claim 16, the operations further comprising:
estimating an initial conditional probability of the initial scene sequence given the initial speaker sequence through off-line training sequences using supervised learning algorithms.

19. The logic of claim 16, wherein updating the speaker sequence comprises:
computing a conditional probability of the initial speaker sequence given the initial scene sequence;
estimating the updated speaker sequence based on at least the conditional probability of the initial speaker sequence given the initial scene sequence;
comparing the updated speaker sequence with the initial speaker sequence; and
updating the initial determined speaker sequence to the updated speaker sequence if there is a difference between the updated speaker sequence and the initial speaker sequence.

20. The logic of claim 16, the operations further comprising:
estimating an initial conditional probability of the initial speaker sequence given the initial scene sequence through off-line training sequences using supervised learning algorithms.
